(19) United States
(12) Patent Application Publication
(10) Pub. No.: US 2026/0169772 A1
(43) Pub. Date: Jun. 18, 2026

(54) COMMAND-LINE INTERFACE CONTEXTUAL EXECUTABLE ACTIONS INTERFACE

(71) Applicant: International Business Machines Corporation, Armonk, NY (US)

(72) Inventors: Paritosh RANJAN, Kolkata (IN); Bhubaneswar PADHAN, KOLKATA (IN); Prodip ROY, Kolkata (IN); SWARUP KUMAR SIKDER, Kolkata (IN)

(21) Appl. No.: 18/985,201

(22) Filed: Dec. 18, 2024

(51) Int. Cl. G06F 9/455

(52) U.S. Cl. CPC G06F 9/45512

(57) ABSTRACT

Mechanisms are provided for automatic generation of command-line interface (CLI) commands based on a prior CLI output. A CLI command is executed via a CLI to generate a CLI output. The CLI output is processed to identify component(s) of the CLI output. For each component, action(s) are identified to thereby generate a plurality of action metadata. The CLI output is augmented with the identified component(s) corresponding action metadata to thereby generate a second CLI output. The second CLI output is generated and presented in response to a user input to select a component in the second CLI output, user interface (UI) element(s) associated with actions in the action metadata associated with the selected component. In response to a user selecting a UI element, an action corresponding to the user selected UI element is automatically executed.

### BACKGROUND

The present application relates generally to a data processing apparatus and method and more specifically to a computing tool and computing tool operations and functionality for providing a command-line interface contextual executable actions interface.

A Command-Line Interface (CLI), also known as a command prompt or terminal, is a text-based interface through which users may interact with a computer program, operating system, or the like, by inputting lines of text called command-lines. The CLI responds to such command-lines by returning a text-based feedback from the computing system. CLI commands can perform various functions including system configuration, software installation, file manipulation, and the like.

While CLIs provide powerful tools for interacting with software and operating systems, the CLIs require that users be familiar with the specific commands and syntax of the particular CLI. Different CLIs use different commands and syntax. For example, to navigate to a directory, in a Unix system, one may use the “ls” command to list the directory contents and the “cd” command to change the current directory; while in a Microsoft Windows system, one may need to use the “cd” command to change the directory or list the content of a directory with the “dir” command. One must further know what other parameters and ordering of parameters may be needed for each command. Thus, current CLIs require users to have detailed knowledge of the particular CLIs being utilized.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method in a data processing system is provided for automatic generation of Command-Line Interface (CLI) commands based on a prior CLI output. The method comprises executing a first CLI command via a CLI to generate a first CLI output and processing the first CLI output to identify one or more components of the first CLI output. The method comprises identifying one or more actions for each component in the identified one or more components to thereby generate a plurality of action metadata. In addition, the method comprises augmenting the first CLI output to associate with the identified one or more components corresponding action metadata from the plurality of action metadata to thereby generate second CLI output. Moreover, the method comprises, in response to a user input to select a component in the second CLI output, presenting one or more User Interface (UI) elements associated with actions in the action metadata associated with the selected component. Furthermore, the method comprises, in response to a user selecting a UI element from the one or more UI elements, automatically executing an action corresponding to the user selected UI element.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a Command-Line Interface (CLI) contextual executable actions interface engine in accordance with one illustrative embodiment;

FIG. 3 is an example diagram of a unique tag for a CLI command and the corresponding component metadata for components of a CLI output in accordance with one illustrative embodiment;

FIG. 4A is an example diagram of one CLI output user interface generated in accordance with at least one illustrative embodiment;

FIG. 4B is an example diagram of another CLI output user interface generated in accordance with at least one illustrative embodiment; and

FIG. 5 is an example flowchart outlining an example operation for generating a contextually decorated CLI output in accordance with one illustrative embodiment.

### DETAILED DESCRIPTION

The illustrative embodiments provide a computing tool and computing tool operations and/or functionality for providing a command-line interface contextual executable actions interface. The mechanisms of the illustrative embodiments provide executable context aware actions on specific items of a command-line output in a context menu. The illustrative embodiments add intelligence to the output of the commands executed on Command-Line Interfaces (CLIs) and provide an easy to use interface with actions to operate a command-line without any change in the user interface hardware or technology.

As noted above, various CLIs are known to exist, and users currently must have intimate knowledge of the commands and syntax of the commands in order to make use of these CLIs. The commands executed in the CLI emit textual output which is printed in the CLI itself after the command is executed. The textual output that the CLI emits is referred to herein as the CLI output.

It has been recognized that certain types of operations, e.g., application management operations, file management operations, networking, and the like, may be executed using a CLI but require the execution of a series of CLI commands in the CLI. Each CLI command in the series of CLI commands may be dependent on the output of the previous CLI command. In such situations, currently, a user would need to keep referring back to certain items from the outputted text of the CLI, e.g., the CLI output of the previous CLI command, by typing/copying/tabbing in order to form the next CLI command to execute. This manual typing/copying/tabbing of items of outputted text from the CLI output to form new commands is error-prone, cumbersome, and time consuming, and it also requires that the user be aware of the CLI command syntax.

In accordance with the illustrative embodiments, this cumbersome and error-prone operation is avoided by augmenting the CLI's output mechanisms to have contextually appropriate executable actions presented to the user via a User Interface (UI). The illustrative embodiments provide computing tools that tag the CLI command that generated a CLI output, determine the appropriate action templates for the components of the CLI output based on the context of the CLI output, and present a UI in combination with the components of the CLI output which presents accessible UI elements for implementing actions based on the action templates.

That is, after a user inputs a CLI command into a CLI, the CLI generates a CLI output corresponding to the results of executing the CLI command. The CLI output comprises a plurality of components, e.g., names of files, names of servers, names of pods in a cluster, etc. The “components” are the substantive elements of the CLI output which are the focus or subject of the previously executed CLI command. The mechanisms of the illustrative embodiments parse the components based on the context of the CLI output. The “context,” in some of the illustrative embodiments, is the CLI command that was executed by the CLI to generate the CLI output; however, in other illustrative embodiments, the context may be another previously executed CLI command within a CLI command window, e.g., within the past n CLI commands. The context informs the mechanisms of the illustrative embodiments as to how to identify and understand the components in the CLI output and their metadata so as to provide executable actions in a decorated CLI output, as discussed hereafter. Each CLI command is a separate context. Every CLI command execution has its own metadata file associated with the CLI output generated by the execution of the CLI command; the metadata file compiles the metadata for each of the components in the CLI output. Even execution of the same or different CLI commands are considered separate contexts.

A user may manually select the context by selecting from a list of previously executed n CLI commands. By default, the latest CLI command execution would be the automatically determined current context; this default is overridden if a user selects another context from within the CLI command window. For example, suppose that CLI command 1 is a command that generates a list of servers. Assume that CLI command 1 is executed and it returns the following CLI output: server 1, server 2. If CLI command 1 is executed again, after some time, this second execution of the CLI command 1 may generate a different CLI output that returns: server 1, server 2, server 3. The metadata information about server 3 would not be present in the metadata file for the first run of CLI command 1. Thus, every separate command execution of the same or different CLI command is considered a different context.

The CLI command that is executed is tagged with a unique tag. In some cases, this unique tag may be a hash of the CLI command, but other mechanisms for generating or assigning a unique tag may be used without departing from the spirit and scope of the present invention. The unique tag may be used to perform a lookup in a command repository to determine if the same command has been previously processed by the CLI and a corresponding set of actions and corresponding action templates for a UI have already been generated for components of the CLI output of this command. If not, the components of the CLI output are identified and correlated with one or more predefined action templates specifying actions that can be performed with regard to that particular type of component and having code that implements the actions should the user select them. The determination of the action templates is based on the identified context, e.g., by default the previously executed CLI command that generated the CLI output.

The resulting set of actions and their templates are then presented in a UI as user selectable UI elements such as in response to a user interacting with the component in the CLI output, e.g., a user “right-clicking” a component in a listing of components in the CLI output. In response to the user selecting a UI element from this augmented presentation of the CLI output, e.g., the presentation of a contextually decorated CLI output, a new CLI command may be automatically generated using the corresponding action template of the action that corresponds to the selected UI element, and the new CLI command may be automatically input to the CLI for execution and generation of a new CLI output. This process can be repeated for each CLI output generated by the CLI in response to a user input CLI command or an automatically generated and executed CLI command.

For example, with the mechanisms of the illustrative embodiments, if a CLI is used to perform a file system management operation resulting in a listing of the files in a directory, such as by typing “ls” in the CLI, the user is presented with a UI through which the user can select a file name in the resulting CLI output listing of files. The user may then “right-click” with a computer mouse, or otherwise provide an input to select the file name, which causes a pop-up menu (or other UI element) to be presented. The user may then, via this pop-up menu or other UI element, select an option and an ultimate action, such as “File” and then the “Delete” action, in order to delete the file corresponding to the selected file name. The presentation of options and actions in the UI element may have various levels for different combinations of actions, e.g., there may be multiple possible actions below the “File” option level, or multiple different actions at the selectable top component level (at the same level as the “File” option). For example, the option at the top level of the multi-level UI may correspond to the specific type of component selected in the CLI output, as well as other more standardized options, with subsequent UI levels presenting UI elements corresponding to actions and/or sub-actions that may be user selectable to cause the corresponding action/sub-action to be automatically executed with regard to the selected component.

As another example, with the mechanisms of the illustrative embodiments, if a CLI is used to perform a container management operation, a user may list the pods in a cluster by typing a “kubectl get pods” command into the CLI. The user is presented with a listing of the pods as the CLI output from which the user may select a pod name and access a UI element, e.g., a pop-up menu or the like, through which the user may select a “Pod” option and an “Exec” option which causes the user to land on the “bash” of the pod action UI element.

In still another example, if a CLI is used to perform a cloud management operation, a user can obtain a listing of the servers of a cloud account by typing in, for example, the “ibmcloud sl vs list” command. The user interacts with the resulting CLI output by selecting a server from the listing; the user may be presented with a UI element through which the user can select the “server” option and then the “reboot” action UI element. As a result, the selected server would then be automatically rebooted by generating a new CLI command automatically that is input to the CLI and executed.

It should be appreciated that in each of the above examples, the actions presented through the UI element will be automatically determined and customized to the particular selected component based on the type of component and the context of the component, e.g., the previous CLI command. Moreover, by providing user selectable elements in the UI rather than requiring the user to type/copy/tab to generate the CLI command to achieve a desired operation, the likelihood of an error in the generation of the subsequent CLI command is minimized.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a functionality for automatically presenting user selectable contextually relevant actions for components of CLI outputs. The improved computing tool implements mechanism and functionality, such as a command-line interface (CLI) contextual executable actions interface engine, which cannot be practically performed by human beings either outside of, or with the assistance of, a technical environment, such as a mental process or the like. The improved computing tool provides a practical application of the methodology at least in that the improved computing tool is able to automatically generate context based computer executable actions for components of a CLI output which may be user selectable via one or more UI elements.

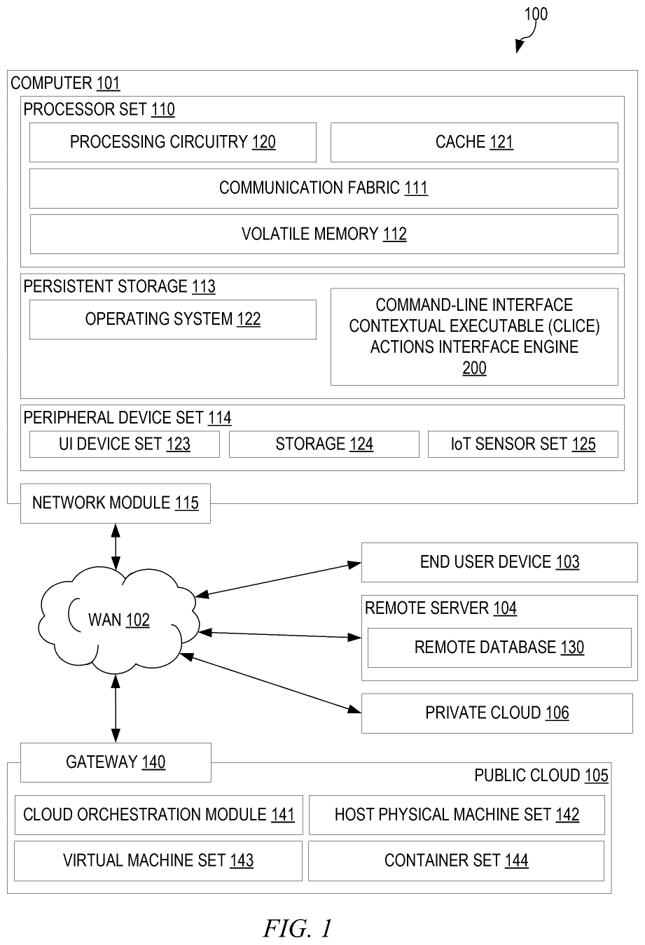

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as CLI contextual executable actions interface engine 200. In addition to CLI contextual executable actions interface engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CLI contextual executable actions interface engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in CLI contextual executable actions interface engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in CLI contextual executable actions interface engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a CLI contextual executable actions interface engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated generation of CLI output context dependent UI elements for performing series of CLI commands to accomplish operations that require multiple CLI command inputs.

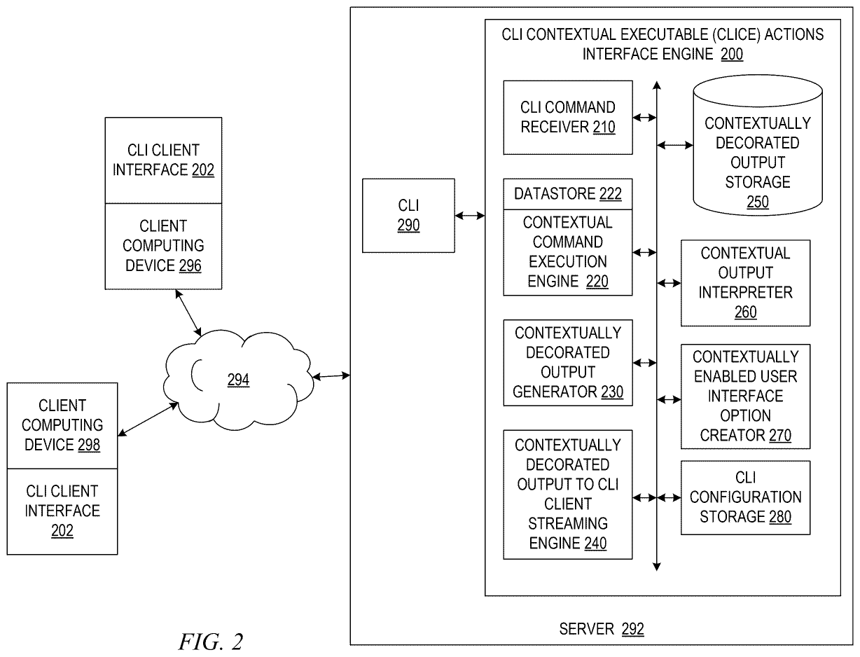

FIG. 2 is an example block diagram illustrating the primary operational components of a Command-Line Interface (CLI) contextual executable actions interface engine in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that complex CLI operations are performed, e.g., those requiring a series of CLI commands to accomplish the overall task. The illustrative embodiments provide a specific solution that implements CLI output analysis and identification of context specific action item User Interface (UI) elements for components of CLI outputs. The illustrative embodiments further provide a specific solution that includes the automated performance of the corresponding actions based on a user selection of the UI elements. These features of the illustrative embodiments cannot be practically performed by human beings as a mental process and are not directed to organizing any human activity.

As shown in FIG. 2, the CLI contextual executable (CLICE) actions interface engine 200 comprises a CLI command receiver 210, a contextual command execution engine 220, a contextually decorated output generator 230, a contextually decorated output to CLI client streaming engine 240, a contextually decorated output storage 250, a contextual output interpreter 260, a contextually enabled user interface option creator 270, and a CLI configuration storage 280. The CLICE actions interface engine 200 operates in conjunction with a CLI 290 provided on the same or a different data processing system. In the depicted example, the CLI 290 and CLICE actions interface engine 200 are provided on the same data processing system 292, but commands may also be received via one or more data networks 294 from client computing devices 296-298. In the illustrative embodiments described herein, while the CLI 290 is shown to be a separate element from the CLICE actions interface engine 200, in other illustrative embodiments, these elements 290 and 200 may be integrated with one another. In some illustrative embodiments, the CLI command receiver 210, contextual command execution engine 220, and contextual decorated output generator 230 may be implemented locally relative to the CLICE actions interface engine 200 or remotely from the CLICE actions interface engine 200, such as on one or more of the client computing devices 296-298.

With the mechanisms of the illustrative embodiments, a user may trigger a CLI command (also simply referred to as a “command” herein) on the CLI 290, which again may be local, remote, or even integrated with the CLICE actions interface engine 200. The user may trigger the command by inputting a textual command into the CLI 290 via a CLI client interface 202 of a client computing device 296-298, for example, or the command may be automatically generated by an application or by the CLICE actions interface engine 200, as discussed hereafter. The command directed to the CLI 290 is received by the CLI command receiver 210 which provides the command to the contextual command execution engine 220. The contextual command execution engine 220 can execute the command on a local or remote computing device using, for example, local libraries, REST, gRPC, or the like.

The contextual command execution engine 220 performs the action required by the command, e.g., extracting details of all files in a directory, extracting details of a deployment in a containerized service cluster, extracting details of all servers or virtual machines of a cloud account, showing the network file storages provisioned in a cloud account, displaying the network interfaces attached to a computer device, calling a REST API which returns a JSON containing all infrastructure details of all types of cloud resources provisioned in the cloud account, etc. After the contextual command execution engine 220 executes the actions, the contextual command execution engine 220 has the details of the components which are to be provided in the CLI output. The command execution engine 220 has the information about the command actions and other metadata for each type of component such as may be stored in a datastore 222 associated with the command execution engine 220. That is, the datastore 222 may store data structures specifying mappings between component types, contexts, and appropriate actions and action templates such that given a context and a component type, a corresponding set of one or more actions, and their action templates may be identified and used to provide component metadata specifying these actions and action templates. The contextually decorated output generator 230 may refer to this stored component metadata in the datastore 222 for each component of a CLI output to thereby form the complete metadata file for the CLI output which will contain metadata for all types of components included in the CLI output.

The contextual output interpreter 260 comprises computer logic that parses the CLI output to identify the components of the CLI output and their corresponding portions of the metadata file. The contextual output interpreter 260 performs a search of the text of a CLI output to match the text to a tag, e.g., <component-name>, in the metadata file. This is performed for all the components in the CLI output with regard to each of the component descriptions present in the metadata file for the CLI output. The <component-actions> tags, in the component details present in the metadata file, contain the actions which are applicable for the component. For each <component-action> in the metadata file, there is a corresponding <command-template>which explains how to form a new CLI command to perform the corresponding action. The context, e.g., the previously executed CLI command, and component type of components in the CLI output are used to select the actions, e.g., one or more <component-actions>, and action templates, e.g., one or more <command-template>, for the components of the CLI output based on the mappings stored in the datastore 222.

Based on the identification of the components present in the CLI output, the contextually decorated output generator 230 adds tags around the component identifiers, e.g., names or the like, in the CLI output identified by the contextual output interpreter 260, e.g., pods, servers, files, etc., to thereby “decorate” the output. The term “decorated” or “contextually decorated” refers to the metadata for the components in the CLI output being associated with the components in the CLI output as tags. These tags are CLI command execution specific and the metadata associated with the tags “decorate” the CLI output with additional action and action templates specific to the CLI command execution context. By default, the context would be the last CLI command executed. However, as noted above, a user can set the context as any past CLI command executed on the CLI within a given CLI command window, e.g., n previous CLI commands. The stored metadata file of the previously executed CLI command (context) may be used to create the tags in the contextually decorated CLI output and the corresponding UI options.

The tag based metadata around a component identifier may contain information about the actions which can be performed on that component. For example, if the component is a server, there may be various actions including start, reboot, reload, shutdown, power-off, power-on, and the like that are identified as being available in the context of that component in the CLI output. However, for a component that is a pod in a containerized system cluster, then the actions may be log, execute, add storage, delete, and the like, and, under the execute option, specific actions of “sh” and “bash” may be provided. The tag based metadata may also contain command templates for the commands to implement the corresponding actions with regard to the selected component.

Thus, based on the execution of the action required by the command via the contextual command execution engine 220, and the interpretation and understanding of the components in the CLI output by the contextual output interpreter 260, the contextual decoration of the CLI output by the contextual decorated output generator 230 generates contextually decorated output. The contextually decorated output storage 250 comprises a database which stores the contextually decorated output generated by the contextually decorated output generator 230. The contextually decorated output, comprising the metadata for the components, is stored in the storage 250 in association with the unique identifier of the CLI command so that it can be retrieved for use if the user changes the context to any previously executed CLI command when processing other subsequent CLI commands, for example.

In generating the contextually decorated output, the contextual decorated output generator 230 may generate a unique identifier for the components of the CLI output that will have corresponding metadata with a specified structure. Each component metadata is associated with the unique identifier for the CLI command that generated the CLI output. For example, the component metadata may comprise component name, component type, possible actions, and a command template for each possible action. For each command template, for each possible action, the metadata for that command template may include the action, a corresponding command, parameters, and any subcommands whose structure will be the same as the command. The component metadata may be encoded in the unique identifier for the CLI command to thereby associate the CLI output's components with the CLI command.

The contextually enabled user interface option creator 270 generates the UI elements for components through which a user may select actions to be performed with regard to a selected component of the CLI output and any appropriate CLI options for these actions. The CLI output then automatically generates a CLI command to execute the corresponding action. Action templates that correspond to these actions are used to automatically generate new CLI commands for submission to the CLI 290 which then executes the new CLI commands. The UI elements associated with a particular component are specifically generated for that particular component within the given context, e.g., the previously executed CLI command. The UI elements may be presented using any suitable UI component, e.g., pop-up menu, drop-down menu, selectable text or images, and the like. The required information for rendering these UI elements is presented in the stream of the contextually decorated output. The stream is streamed by the contextually decorated output from CLI client streaming engine 240 to the CLI client interface 202 that submitted the original CLI command, e.g., a text output of the command execution is streamed to the CLI client interface 202. The text output may be augmented or contextually decorated at the CLI client interface 202 to include the tags corresponding to the metadata file of the CLI output.

At the CLI client interface 202, the user may interact with the contextually decorated CLI output to select a UI element for an action associated with a component in the CLI output. For example, a user may be presented with the contextually decorated CLI output by the streaming engine 240 and via the CLI client interface 202. At the CLI client interface 202, the components that may have associated tags generated by the mechanisms of the illustrative embodiments may be conspicuously identified in the presentation of the contextually decorated CLI output, e.g., highlighted, colored in a different color, different font, different font size, or the like. In some cases, components of the same component type may be conspicuously identified in a similar manner, e.g., all pods are colored in a first color, all servers are colored in a second color, all files are colored in a third color, or the like.

A user may then “right-click” on, or otherwise select, a component to trigger the presentation of the actions that may be performed in association with the component via the UI elements corresponding to the actions specified in the metadata tags associated with the selected component. In response to the user selecting an action in the UI elements, the corresponding action template is used to generate a new CLI command to perform that action on the particular selected component. The automatically generated new CLI command may then be submitted to the CLI 290 for execution and the process may be repeated with the additional CLI output generated as a consequence of this new CLI command.

The new CLI command will have parameters that may be automatically obtained from the metadata generated from the execution of the CLI command. However, in some cases, UI elements may be provided to receive user input for specifying particular parameters or parameter values for inclusion in the new CLI command. For example, a UI may provide UI elements, e.g., drop down menus, listings of all values of parameters, or any other UI element, to thereby select parameter values based on the metadata generated by the execution of the CLI command. If the metadata indicates that a particular parameter's value needs to be provided by a user, then an appropriate UI element may be provided, e.g., a text box or the like, through which the user can select or input the parameter and/or the parameter value. However, the user would not need to alter the CLI command that is executed, but only select or provide the parameter/parameter value for the execution of the automatically generated CLI command.

As noted above, the actions associated with a component may be bound to a context; as a default, the context may be the last command executed by the CLI. However, in some situations, a user may specify an override of this default context and may specify any of n previous commands. This preference for the context to be used when generating contextually decorated CLI outputs may be specified in the CLI configuration storage 280, e.g., use the default, use the last 10 CLI commands as a CLI window from which a user selects the applicable context, or the like.

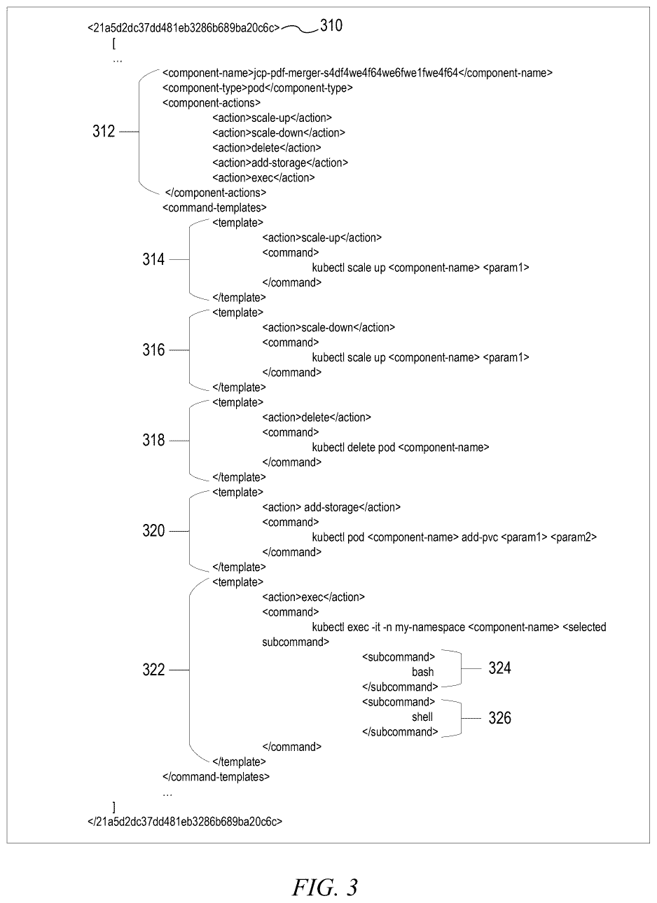

As mentioned above, the CLI command has a unique tag which encodes the components and their associated actions and action templates. FIG. 3 is an example diagram of a unique tag for a CLI command and the corresponding component metadata for components of a CLI output in accordance with one illustrative embodiment. As shown in FIG. 3, the CLI command tag 310 is a unique string of text, such as a hash value or the like, which uniquely identifies the CLI command and corresponding CLI output components and encodes the various component metadata, actions, and action templates. As shown in FIG. 3, a component's metadata 310 includes a component type, component actions listing 312, command templates for the actions 314-322, which in some cases includes subcommands as well, e.g., command template 322 comprises subcommands 324 and 326.

Thus, in determining what actions and what action templates are appropriate for the particular components of the CLI output, given the context, e.g., a previous CLI command, the illustrative embodiments generate the metadata file for the CLI output and read the metadata file to create the UI options which are the basis for the automated, or semi-automated, generation of a subsequent CLI command. In generating the metadata file, the contextual command execution engine 220, which executes the CLI command, knows what components it is writing to the CLI output. The contextual command execution engine 220 also has the information about the command actions and other metadata for each type of component stored in a datastore 222 associated with the contextual command execution engine 220. The contextually decorated output generator 230 refers to this stored component metadata for each component to form the complete metadata file for the CLI output which will contain metadata for all types of components in the CLI output.

With regard to reading the metadata file to create the UI options and generate new CLI commands, the metadata file lists component identifiers, e.g., component names, which may be searched for based on a user selection of a component in the decorated CLI output presentation. That is, a user may select a component in the CLI output and that selection is used to perform a search of the metadata file for a corresponding portion of metadata for that component. The corresponding metadata in the metadata file is then used to automatically generate the UI options for that selected component in the CLI output presentation. The user may then select a UI option to thereby select the action causing the action template to be used to generate a new CLI command to execute the action. The parameters for the new CLI command may be automatically determined from the metadata file and/or in some cases may be provided by user input to one or more UI elements if needed.

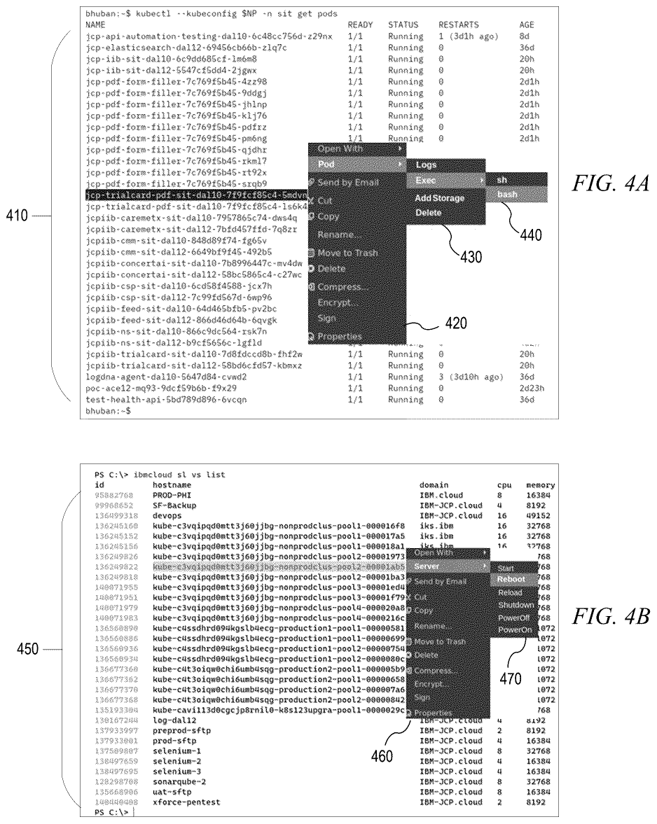

As discussed above, the CLI command's unique identifier or tag may be used to drive the presentation of UI elements in the presentation of the contextually decorated CLI output via the CLI client interface. FIG. 4A is an example diagram of one CLI output user interface generated in accordance with at least one illustrative embodiment. The CLI output user interface as shown in FIG. 4A is for a CLI output that provides a listing of the pods of a cluster via a command in a CLI. As shown in FIG. 4A, the CLI output, which is contextually decorated by the present invention, includes a listing of the pods of the cluster 410. The pods in the listing are the components of the CLI output and are user selectable via the CLI client interface. In response to the user selecting one of these pods, e.g., by right-clicking on the pod name in the listing, a pop-up mention is presented 420 having an option for “Pod” which is the component type of the selected component.

In response to the user selecting “Pod,” the user is presented with a listing of actions 430 that are appropriate for the selected “Pod” as indicated by the component metadata encoded in the unique identifier/tag for the CLI command. In this case, the action list 430 includes actions of “Logs,” “Exec,” “Add Storage,” and “Delete,” In response to the user selecting “Exec,” the user is presented with subcommands 440 of “sh” and “bash”. By selecting bash, a new CLI command is automatically generated and input to the CLI to thereby log into the selected pod. If one were to try to perform this operation manually, they would have to refer to the pod listing and manually input the command “kubectl —kubeconfig kue-config.yaml -n production exec -it jcp-trialcard-pdf-sit-dal10-7f9fcf85c4-5mdvn -- /bin/bash.” This requires a user to have knowledge of the CLI and its commands and parameters for the commands as well as manual referencing back to the CLI output to populate a manual command. The illustrative embodiments eliminate all this effort through the automated contextual decoration of the CLI output and providing of UI elements specific to the components and context of the CLI output.

FIG. 4B is an example diagram of another CLI output user interface generated in accordance with at least one illustrative embodiment. The example shown in FIG. 4B is for rebooting a server from a server listing generated via a command in CLI. In this case, the CLI command “ibmcloud sl vs list” is used to generate a listing of servers 450 of a cloud account. Each server in the listing 450 is a component of the CLI output and is user selectable similar to the pods in FIG. 4A. In response to selecting, e.g., right-clicking, on a particular server, the user is presented with the pop-up menu 460 which includes an option for “Server,” which is the component type. In response to selecting the “Server” option, the user is presented with a listing of UI elements for the actions 470 available to be performed on the server, e.g., start, reboot, reload, shutdown, power-off, and power-on.

In response to the user selecting the “Reboot” action, the illustrative embodiments utilize the template in the component metadata corresponding to the action of “Reboot” to thereby generate a new CLI command to cause the selected server to be rebooted. This new CLI command is automatically submitted to the CLI which then executes the command to perform the action and generate a corresponding CLI output. If one were to try to do this manually, the user would have to enter the command “ibmcloud sl vs reboot kube-c3vqipq0mtt3j60jjbg-nonprodclus-pool2-00001ab5 -f” which, again, requires a knowledge of the CLI, the commands, the command parameters, and the like and requires referencing back to the CLI output to populate the command. These knowledge requirements and manual referencing are again avoided by the mechanisms of the illustrative embodiments.

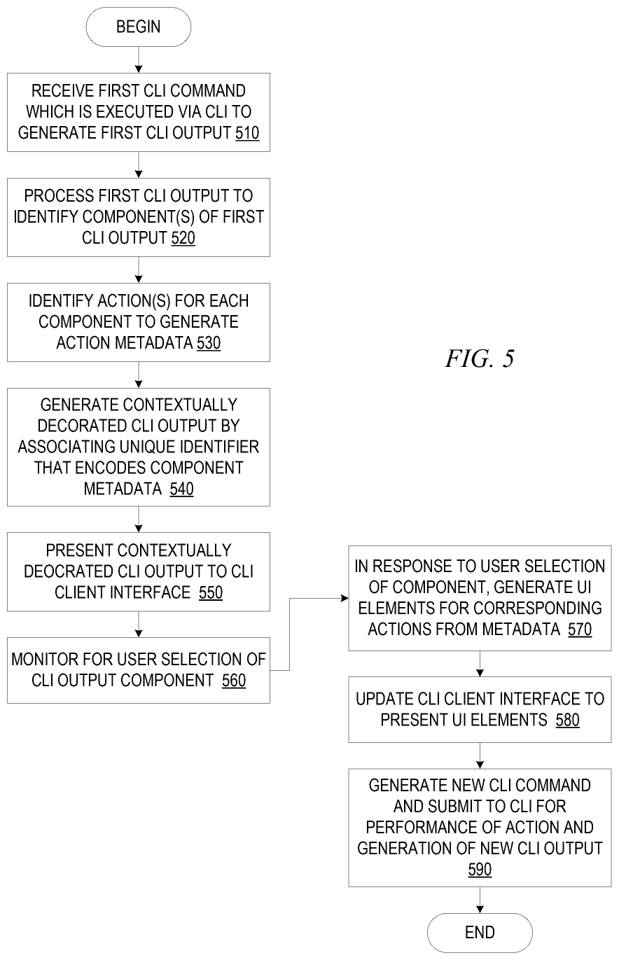

FIG. 5 is an example flowchart outlining an example operation for generating a contextually decorated CLI output in accordance with one illustrative embodiment. It should be appreciated that the operations outlined in FIG. 5 are specifically performed automatically by a computer tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the computing tool in an automated manner.

As shown in FIG. 5, the operation starts by receiving a first CLI command which is executed via the CLI to generate a first CLI output (step 510). The first CLI output is processed to identify one or more components of the first CLI output (step 520). For each identified component, one or more actions for that component are identified to thereby generate action metadata for that component (step 530). The action metadata may include an action listing and corresponding action templates for each of the actions. The action metadata may be encoded into a unique identifier for the first CLI command which is then associated with the CLI output to thereby generate a contextually decorated CLI output (step 540). The unique identifier may be used to retrieve or generate the action listing and action templates. The action listing and action templates may be associated with the components in the CLI output by performing a textual matching between the component identifier in the CLI output and the component identifier in the component metadata encoded in the unique identifier.

The contextually decorated CLI output is presented to the user via the CLI client interface as a response to the first CLI command (step 550). Thereafter, the system monitors for a user selection of a CLI output component in the contextually decorated CLI output (step 560). In response to a component being selected, the corresponding component metadata is used to identify what actions to present to the user as options in one or more UI interface elements for selection by the user (step 570). The CLI client interface is updated to present these UI interface elements (step 580) and, in response to a user selecting a UI interface element, the action template is used to generate a new CLI command that is submitted to the CLI to perform the action (step 590). The operation then terminates. While the operation is shown as terminating at this point, it should be appreciated that this process may be repeated with the subsequent CLI output generated as a consequence of this new CLI command, or entry of other CLI commands by the user.

The description of the present invention has been presented for purposes of illustration and description and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method in a data processing system for automatic generation of command line interface (CLI) commands based on a prior CLI output, the method comprising:
executing a first CLI command via a CLI to generate a first CLI output;
processing the first CLI output to identify one or more components of the first CLI output;
identifying one or more actions for each component in the identified one or more components to generate a plurality of action metadata;
augmenting the first CLI output to associate, with the identified one or more components, corresponding action metadata from the plurality of action metadata to thereby generate second CLI output;
in response to a user input to select a component in the second CLI output, presenting one or more user interface (UI) elements associated with actions in action metadata associated with the selected component; and
in response to a user selecting a UI element from the one or more UI elements, automatically executing an action corresponding to the user selected UI element.

2. The method of claim 1, wherein identifying the one or more actions further comprises identifying an action template for generating a subsequent CLI command to execute the action, for each action in the one or more actions.

3. The method of claim 2, wherein automatically executing the action corresponding to the user selected UI element comprises:
automatically generating the subsequent CLI command based on the identified action template;
inputting the subsequent CLI command into the CLI; and
receiving a new CLI output based on an execution of the subsequent CLI command by the CLI.

4. The method of claim 1, wherein identifying the one or more actions further comprises:
determining a component type of the component selected by the user input;
determining a context based on previously executed CLI commands including the first CLI command; and
correlating the component type and context with an entry in a datastore that stores mappings of contexts, component types, and sets of actions and action templates.

5. The method of claim 1, further comprising, for each component in the identified one or more components, identifying one or more actions for the component comprises determining a context of the CLI output, wherein different actions are applicable to different contexts.

6. The method of claim 5, wherein the context of the CLI output is the first CLI command by default, and wherein the context may be specified by a user to override the default of the first CLI command.

7. The method of claim 1, wherein the second CLI output comprises, for each component in the second CLI output, corresponding tags that specify actions and action templates associated with the component, and wherein user interface elements are generated from the actions and action templates associated with the component when presenting the second CLI output via the CLI client interface.

8. The method of claim 7, wherein the presentation of the second CLI output comprises a hierarchy of option user interface (UI) elements, action UI elements, and sub-action UI elements which are user selectable.

9. The method of claim 1, wherein the plurality of action metadata comprises a metadata file corresponding to the first CLI output, and wherein the metadata file comprises, for each component in the first CLI output, a component identifier, a component type, a component actions listing, and a command template listing.

10. The method of claim 1, wherein the components comprises one or more of names of files, names of servers, or names of pods in a container orchestration system cluster.

11. A computer program product comprising a computer readable storage medium having a computer readable program stored therein, wherein the computer readable program, when executed in a data processing system, causes the data processing system to:
execute a first Command-Line Interface (CLI) command via a CLI to generate a first CLI output;
process the first CLI output to identify one or more components of the first CLI output;
identify one or more actions for each component in the identified one or more components to generate a plurality of action metadata;
augment the first CLI output to associate, with the identified one or more components, corresponding action metadata from the plurality of action metadata to thereby generate second CLI output;
present, in response to a user input to select a component in the second CLI output, one or more user interface (UI) elements associated with actions in action metadata associated with the selected component; and
automatically execute, in response to a user selecting a UI element from the one or more UI elements, an action corresponding to the user selected UI element.

12. The computer program product of claim 11, wherein identifying the one or more actions further comprises identifying an action template for generating a subsequent CLI command to execute the action, for each action in the one or more actions.

13. The computer program product of claim 12, wherein the computer readable program further causes the data processing system to automatically execute the action corresponding to the user selected UI element at least by:
automatically generating the subsequent CLI command based on the identified action template;
inputting the subsequent CLI command into the CLI; and
receiving a new CLI output based on an execution of the subsequent CLI command by the CLI.

14. The computer program product of claim 11, wherein the computer readable program further causes the data processing system to identify the one or more actions at least by:
determining a component type of the component selected by the user input;
determining a context based on previously executed CLI commands including the first CLI command; and
correlating the component type and context with an entry in a datastore that stores mappings of contexts, component types, and sets of actions and action templates.

15. The computer program product of claim 11, wherein, for each component in the identified one or more components, identifying one or more actions for the component comprises determining a context of the CLI output, wherein different actions are applicable to different contexts.

16. The computer program product of claim 15, wherein the context of the CLI output is the first CLI command by default, and wherein the context may be specified by a user to override the default of the first CLI command.

17. The computer program product of claim 11, wherein the second CLI output comprises, for each component in the second CLI output, corresponding tags that specify actions and action templates associated with the component, and wherein user interface elements are generated from the actions and action templates associated with the component when presenting the second CLI output via the CLI client interface.

18. The computer program product of claim 17, wherein the presentation of the second CLI output comprises a hierarchy of option user interface (UI) elements, action UI elements, and sub-action UI elements which are user selectable.

19. The computer program product of claim 11, wherein the plurality of action metadata comprises a metadata file corresponding to the first CLI output, and wherein the metadata file comprises, for each component in the first CLI output, a component identifier, a component type, a component actions listing, and a command template listing.

20. An apparatus comprising:
at least one processor; and
at least one memory coupled to the at least one processor, wherein the at least one memory comprises instructions which, when executed by the at least one processor, cause the at least one processor to:
execute a first Command-Line Interface (CLI) command via a CLI to generate a first CLI output;
process the first CLI output to identify one or more components of the first CLI output;
identify one or more actions for each component in the identified one or more components to generate a plurality of action metadata;
augment the first CLI output to associate, with the identified one or more components, corresponding action metadata from the plurality of action metadata to thereby generate second CLI output;
present, in response to a user input to select a component in the second CLI output, one or more user interface (UI) elements associated with actions in action metadata associated with the selected component; and
automatically execute, in response to a user selecting a UI element from the one or more UI elements, an action corresponding to the user selected UI element.
